(19) United States
(12) Patent Application Publication
(10) Pub. No.: US 2010/0162728 A1
(43) Pub. Date: Jul. 1, 2010

(54) THERMOELECTRIC NANOWIRE ARRAY WITH LOW HEAT LEAKAGE AND MANUFACTURING METHOD THEREOF

(75) Inventor: Wen-Jin Lee, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Industrial Technology Research Institute, Hsinchu (TW)

(21) Appl. No.: 12/414,796

(22) Filed: Mar. 31, 2009

(30) Foreign Application Priority Data
Dec. 31, 2008 (TW) 097151825

(51) Int. Cl. F25B 21/04; B05D 5/12; C23C 28/00

(52) U.S. Cl. 62/3.3; 427/97.3; 205/183

(57) ABSTRACT

A thermoelectric nanowire array with a low heat leakage and a manufacturing method thereof are described. Nanowire array units separated from each other are formed on a substrate, and an air wall is formed at a region on the substrate free of the nanowire array units. Or, a polymeric material having a low thermal conductivity is combined with a template material so as to form a composite template structure for nanowires to deposit therein. With the design of the air wall or the composite template structure, the thermal reflow phenomenon of the thermoelectric nanowire array is avoided, thereby greatly improving a thermal dissipation efficiency of the thermoelectric nanowire array.

### CROSS-REFERENCE TO RELATED APPLICATIONS

This non-provisional application claims priority under 35 U.S.C. §119(a) on Patent Application No(s). 097151825 filed in Taiwan, R.O.C. on Dec. 31, 2008 the entire contents of which are hereby incorporated by reference.

### BACKGROUND OF THE INVENTION

1. Field of Invention

The present invention relates to a nanowire array and a manufacturing method thereof, and more particularly to a thermoelectric nanowire array with a low heat leakage and a manufacturing method thereof.

2. Related Art

A heat transfer device has wide applications in various heating/cooling and power generation/heat recovery systems, for example, in fields such as refrigeration, air conditioning, electronic element cooling, industry temperature control, waste heat recovery, and power generation. The conversion between thermal energy and electric energy has been a manner of energy utilization currently, and the electronic-mechanical energy conversion has become a core technology of modern machinery and sensor and is expected to have wide applications in industrial technologies.

Thermoelectric device, a solid state heat transfer device, has advantages such as high reliability, small size, light-weight, and few noises, and is a potentially candidate to replace the conventional heat transfer device. In a thermoelectric device, heat is transported by electrons and holes through p-type and n-type semiconductor thermal elements. However, currently seen thermoelectric devices have quite high costs with non-ideal efficiency and insignificant economic benefits, and thus are only limited to small-scale applications.

At a fixed operating temperature, the heat transfer efficiency of the thermoelectric device depends on the Seebeck coefficient, electric conductivity, and thermal conductivity of a thermoelectric material that is employed, and is explicitly defined by a ZT value. The definition of the ZT value is as follows:

ZT=S²σT/k,

where S is the Seebeck coefficient (μV/K), σ is the electrical conductivity (S/cm), k is the thermal conductivity (W/(mK)), and T is an absolute temperature (K).

In order to compete with refrigerators or power generators, the ZT value of the thermoelectric device must be larger than 3. However, as can be seen from literatures in recent years, the best ZT value of bulk thermoelectric materials at room temperature merely approaches to 1. The correlations between S, σ, and k make it hard to get the ZT value larger than 1.

In order to solve the above problem, researchers focus on nanoscale thermoelectric material, so as to break through the working efficiency of conventional thermoelectric devices manufactured with bulk materials.

Nanowires have been proved to have a ZT value larger than 1 by theoretical calculation. However, a single nanowire cannot be used in actual refrigeration/power generation applications, so that millions of nanowires must be gathered to transmit a sufficient amount of heat and electric current. Therefore, how to arrange the huge number of nanowires regularly and maintain the mechanical strength is one problem pressing for solution currently.

In order to keep the mechanical strength of a nanowires bundle, numerous thermoelectric nanowires are deposited into a high aspect ratio nano-template to fabricate a thermoelectric nanowire array. In a simple case, the heat transport and generation in a thermoelectric nanowire array for refrigeration application can described by: 1. Peltier effect, which is heat extracted from heat source to heat sink by an electric current; 2. Joule heating, when the electric current passes through a material, heat is generated; and 3. thermal conduction in which thermal energy is transferred from a high temperature area to a low temperature area. For cooling application, the direction of thermal conduction is exactly opposite to the direction of the heat flow extracted by the Peltier effect, and thus a phenomenon of heat leakage (or referred to as parasitic heat of the thermoelectric material) is formed, which seriously reduces the working efficiency of the thermoelectric nanowire array.

The thermal conduction in the thermoelectric nanowire array comes from the nanowires and the nano-template. When the diameter of the nanowires is smaller than tens of nanometers, the thermal conduction of the nanowires is inhibited by the boundary scattering. Besides, thermoelectric materials made from semiconductor materials have a low thermal transfer coefficient. Therefore, the thermal conduction in the nanowires is acceptable. However the heat reflow by the heat conduction in the template becomes most critical to refrigeration applications when the thermal conductivity o the template is higher than that of the nanowires.

The heat leakage problem hasn't been widely described in most disclosed patent. For example, U.S. Patent Application No. 2005/0257821 has disclosed a thermoelectric nanodevice. The thermoelectric nanodevice includes a thermoelectric element manufactured with nanowire bundles consisting of a Bi-containing material, for extracting heat from a heat source on a microelectronic die.

In addition, U.S. Pat. No. 6,969,679 has disclosed a thermoelectric nanodevice. The thermoelectric nanodevice includes a first electrode pattern formed on a substrate. The first electrode pattern has a bottom electrode and a first connecting portion electrically connected to each other. A p-type nanowire and an n-type nanowire are selectively formed on the substrate and electrically connected to each other via a top electrode. A first connecting hole is formed on the substrate to remove a first connecting port. A second connecting hole is electrically adjacent to the bottom electrode. Besides, a second connecting portion is formed.

U.S. Pat. No. 7,267,859 has disclosed a thermoelectric nanoarray. The thermoelectric nanoarray includes a non-aluminum substrate, an adhesion layer, and a porous anodic alumina template (PAA template). The adhesion layer is disposed on the substrate and includes a composite layer structure of SiO₂/Ti/Pt. The PAA template is disposed on the adhesion layer for a plurality of nanowires to form within the template.

Although the thermoelectric nanodevice structures in the above patent applications directly form the template and the nanowire array on a silicon substrate, the disadvantage of such kind of structure design lies in that, the template is completely contact with the silicon substrate. In this way, heat leakage from template reduces the thermal removing efficiency of the thermoelectric nanodevice.

Therefore, how to design a thermoelectric nanowire array structure with a low heat leakage is currently the most important problem to be solved by those skilled in the related field. Reducing parasitic heat transferred back from the region of a high temperature area to a low-temperature area by thermal conduction will improve the working efficiency of the thermoelectric nanowire array.

### SUMMARY OF THE INVENTION

Accordingly, the present invention is directed to a thermoelectric nanowire array with a low heat leakage and a manufacturing method thereof, thereby alleviating the problem that a thermoelectric nanowire array structure in the prior art has poor working efficiency due to the heat leakage effect.

A thermoelectric nanowire array with a low heat leakage and a manufacturing method thereof are provided in a first embodiment of the present invention. The manufacturing steps comprise the following. First, a first electrode is formed on a substrate. Then, the first electrode is patterned, such that the first electrode forms an N-type region and a P-type region separated from each other and exposes a part of the substrate. A template material is formed on the N-type region, the P-type region, and the substrate. Then, the template material is patterned to remove the template material on the substrate. Then, a porous processing is applied to the template material such that the template material is formed with nano-pores, and nanowires are deposited in the nano-pores of the template material so as to respectively form an N-type nanowire array unit and a P-type nanowire array unit. A second electrode is formed on the N-type nanowire array unit and the P-type nanowire array unit, and an air wall is formed between the N-type nanowire array unit and the P-type nanowire array unit. Finally, a thermoelectric nanowire array structure is formed.

A thermoelectric nanowire array with a low heat leakage and a manufacturing method thereof are provided in a second embodiment of the present invention. The manufacturing steps comprise the following. First, a first electrode is formed on a substrate. Then, the first electrode is patterned such that the first electrode forms an N-type region and a P-type region separated from each other and exposes a part of the substrate. Then, a template material having nano-pores is formed on the N-type region, the P-type region, and the substrate, and nanowires are deposited in the nano-pores of the template material at positions corresponding to the N-type region and the P-type region, so as to respectively form an N-type nanowire array unit and a P-type nanowire array unit. A second electrode is formed on the template material. Then, the second electrode is patterned and the part that corresponding to the exposed substrate is removed. Then, a part of the template material corresponding to the exposed substrate is removed. Further, a third electrode is formed on the second electrode on the N-type nanowire array unit and the P-type nanowire array unit, so as to form an air wall. Finally, a thermoelectric nanowire array structure is formed.

A thermoelectric nanowire array with a low heat leakage and a manufacturing method thereof are provided in a third embodiment of the present invention. The manufacturing steps comprise the following. First, a first electrode is formed on a substrate. Then, the first electrode is patterned such that the first electrode forms an N-type region and a P-type region separated from each other and exposes a part of the substrate. Then, a template material having nano-pores is formed on the N-type region, the P-type region, and the substrate, and nanowires are deposited in the nano-pores of the template material at positions corresponding to the N-type region and the P-type region so as to respectively form an N-type nanowire array unit and a P-type nanowire array unit. Then, the template material of a certain thickness is removed, and a polymeric material having low thermal conduction characteristics is filled. If the filled polymeric material is too thick and covers the nanowires, a part of the polymeric material must be removed to expose a part of the nanowires. A second electrode is formed on the polymeric material, and contacts with the exposed nanowires. Finally, a thermoelectric nanowire array structure is formed.

The efficacy of the present invention lies in that, nanowire array units separated from each other are formed on a substrate, and an air wall is formed at a region free of nanowire array units, so as to form a heat leakage barrier layer. Or, a polymeric material having a low thermal conductivity is combined with a template material so as to form a composite template structure for nanowires to deposit therein, so as to reduce the thermal conduction property of the template material. With the design of the air wall or the composite template structure of the present invention, the heat leakage phenomenon of the thermoelectric nanowire array is avoided, thereby greatly improving the performance of the thermoelectric nanowire array.

### BRIEF DESCRIPTION OF THE DRAWINGS

The present invention will become more fully understood from the detailed description given herein below for illustration only, and thus are not limitative of the present invention, and wherein:

FIGS. 1A to 1M are schematic views respectively illustrating steps of a first embodiment of the present invention;

FIG. 2 is a flow chart illustrating steps of the first embodiment of the present invention;

FIGS. 3A to 3M are schematic views respectively illustrating steps of a second embodiment of the present invention;

FIG. 4 is a flow chart illustrating steps of the second embodiment of the present invention;

FIGS. 5A to 5L are schematic views respectively illustrating steps of a third embodiment of the present invention;

FIG. 6 is a flow chart illustrating steps of the third embodiment of the present invention;

FIG. 7 is a schematic structural view of a thermoelectric nanowire array in a different form of the present invention; and

FIG. 8 is a schematic structural view of a thermoelectric nanowire array in a different form of the present invention.

### DETAILED DESCRIPTION OF THE INVENTION

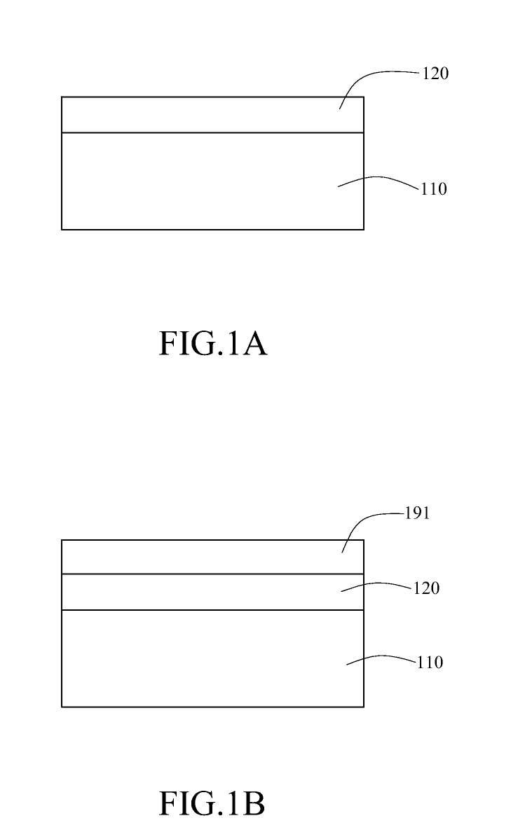

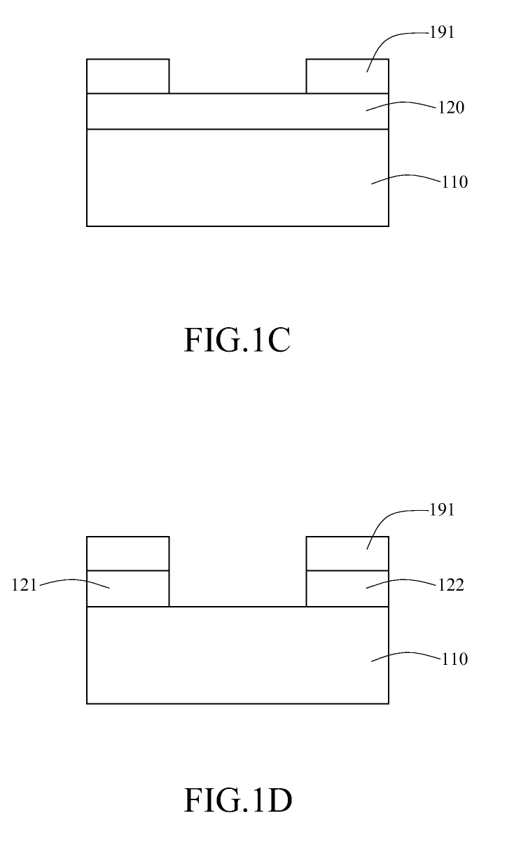

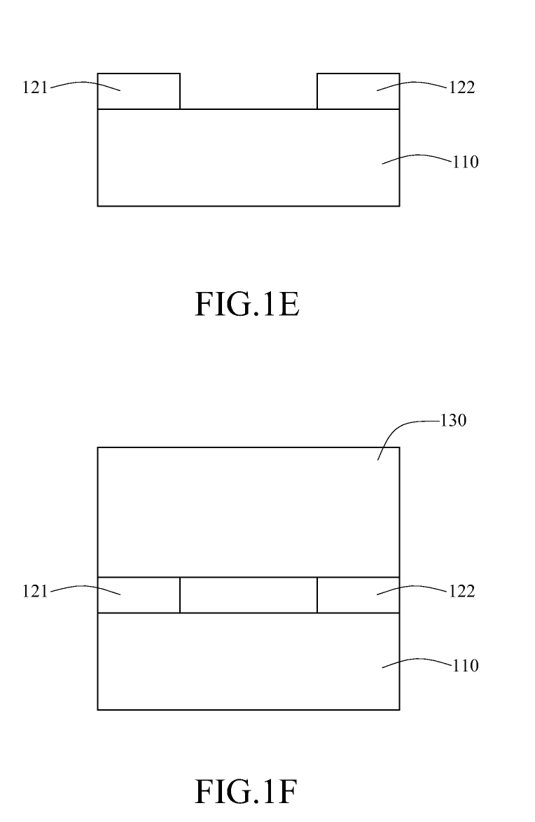

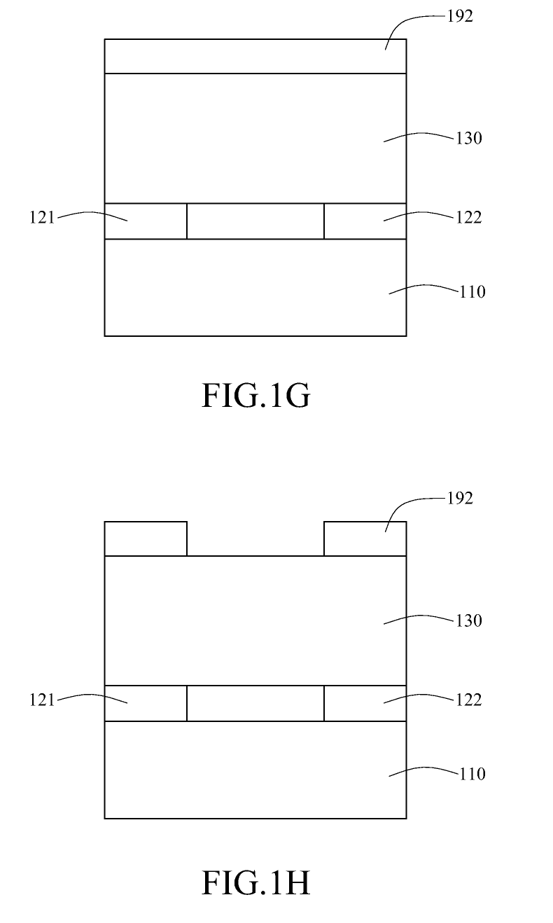

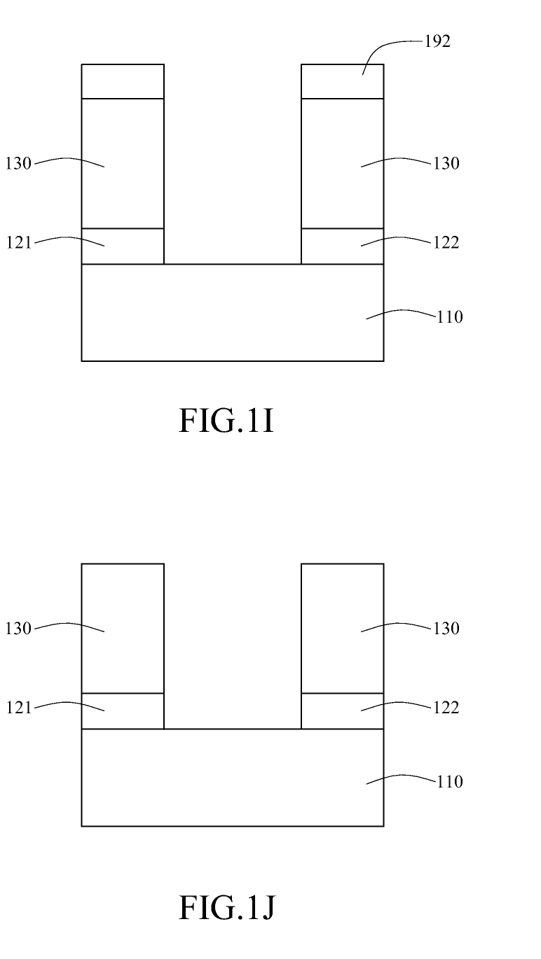

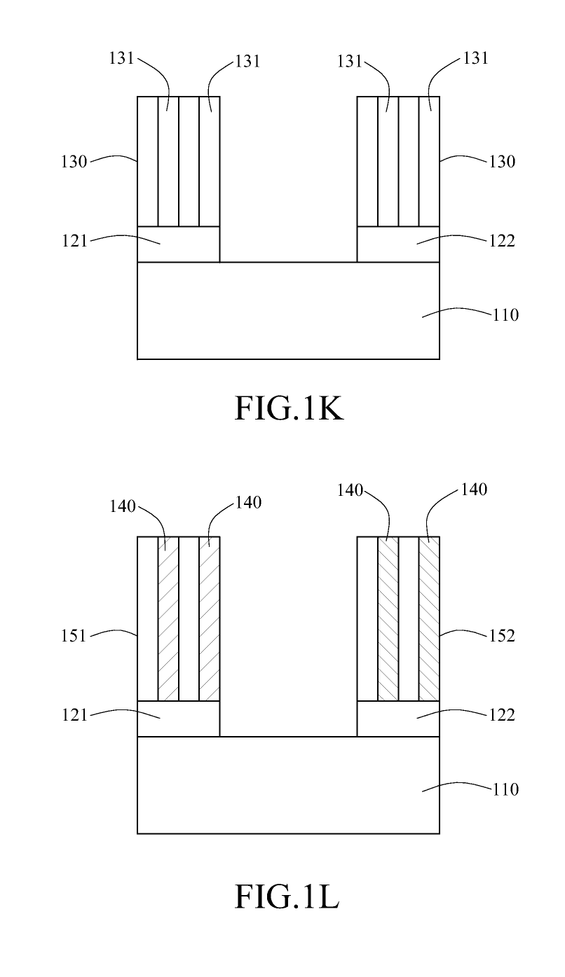

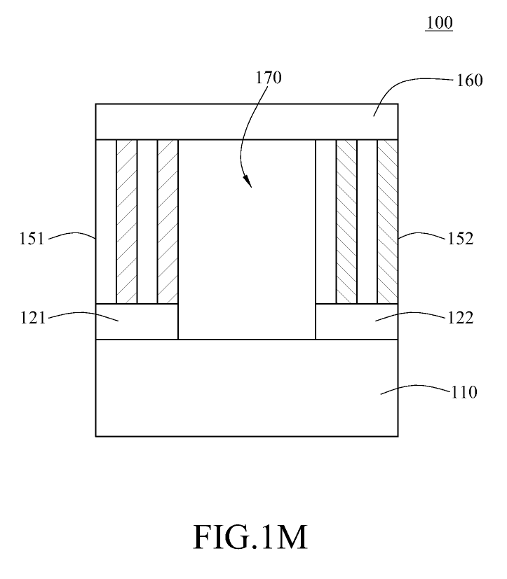

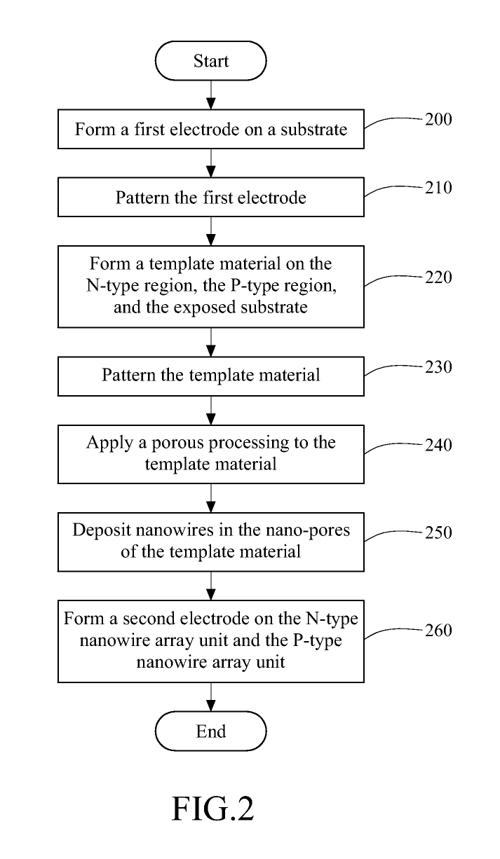

FIGS. 1A to 1M and FIG. 2 are schematic views respectively illustrating steps of a first embodiment of the present invention and a flow chart illustrating steps of the first embodiment of the present invention. Referring to FIGS. 1A to 1E in combination with the flow illustration of steps in FIG. 2, a method for manufacturing a thermoelectric nanowire array with a low heat leakage according to the first embodiment of the present invention is as follows. First, a first electrode 120 is formed on a substrate 110 (Step 200). The substrate 110 is a silicon wafer, and the first electrode 120 is made of, but not limited to, a nickel metal or a nickel-phosphorus alloy. Then, the first electrode 120 is patterned (Step 210). A first photoresist layer 191 is coated on the first electrode 120, and a part of the first photoresist layer 191 is removed by a lithography process in combination with a physical manner or a chemical manner, so as to correspondingly expose a part of the first electrode 120. Then, the exposed first electrode 120 is removed physically or chemically. Finally, the first phtoresist layer 191 is removed, such that the first electrode 120 forms a structure with an N-type region 121 and a P-type region 122 separated from each other by the exposed substrate region.

In the present invention, the part of the first electrode 120 may be removed by wet etching or dry etching methods, and a material of the first photoresist layer 191 is also selected correspondingly according to the employed etching method, and is not limited to the content disclosed in this embodiment.

Referring to FIGS. 1F to 1J in combination with the flow illustration of steps in FIG. 2, after the step of patterning the first electrode 120 (Step 210) is completed, a template material 130 is formed on the N-type region 121, the P-type region 122, and the exposed substrate 110 (Step 220). The template material 130 disclosed in the present invention is made of, but not limited to, an Al₂O₃ material. Then, the template material 130 is patterned (Step 230). A second photoresist layer 192 is coated on the template material 130, and a part of the second photoresist layer 192 is removed by a lithography process in combination with a physical manner or a chemical manner, so as to correspondingly expose a part of the template material 130. A region of the exposed template material 130 is corresponding to an exposed region of the substrate 110. Then, the exposed template material 130 is removed physically or chemically. Finally, the second photoresist layer 192 is removed, such that the template material 130 that is not removed is respectively disposed on the N-type region 121 and the P-type region 122.

In the present invention, the part of the template material 130 may be removed by wet etching or dry etching methods, and a material of the second photoresist layer 192 is also selected correspondingly according to the employed etching method, and is not limited to the content disclosed in this embodiment.

Referring to FIGS. 1K to 1M in combination with the flow illustration of steps in FIG. 2, after the step of patterning the template material 130 (Step 230) is completed, a porous processing is applied to the template material 130 on the N-type region 121 and the P-type region 122 (Step 240), such that the template material 130 is formed with nano-pores 131 (as shown in FIG. 1K). An aperture of the nano-pores 131 may range from several nanometers to hundreds of nanometers. Then, nanowires 140 are deposited in the nano-pores 131 of the template material 130, so as to respectively form an N-type nanowire array unit 151 and a P-type nanowire array unit 152 (as shown in FIG. 1L). In the embodiment disclosed in the present invention, the nanowires 140 are deposited in the nano-pores 131 of the template material 130 in an electrochemical manner, for example, an electrochemical co-deposition manner or an electrochemical atomic layer epitaxy manner. Moreover, in the present invention, the nanowires 140 are made of, but not limited to, a Bi-containing material, for example, Bi₂Te₃, or a non-Bi-containing material, for example, PbTe, AgTe, SbTe, SiGe, or a related alloy thereof. As shown in FIG. 1M, a second electrode 160 is formed on the N-type nanowire array unit 151 and the P-type nanowire array unit 152 (Step 250), so as to form a thermoelectric nanoarray 100 of the present invention, and an air wall 170 is formed between the N-type nanowire array unit 151 and the P-type nanowire array unit 152 to effectively block thermal energy from producing reflux phenomenon therefrom. The second electrode 160 is made of, but not limited to, a nickel metal or a nickel-phosphorus alloy.

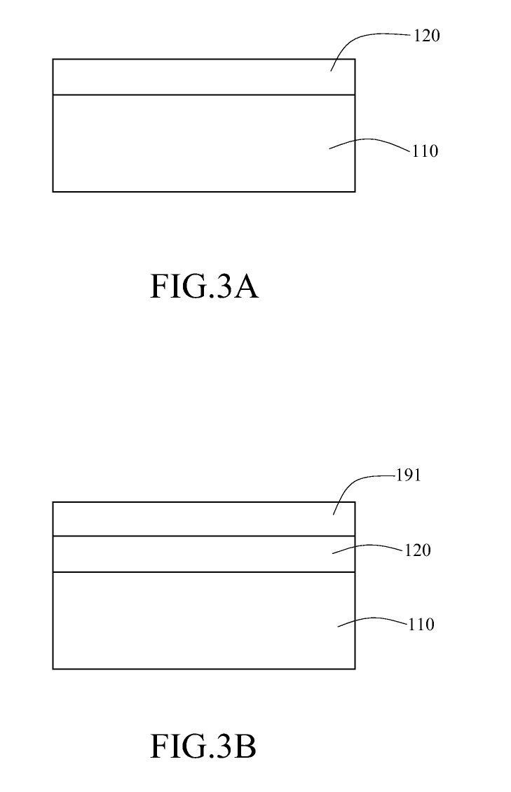

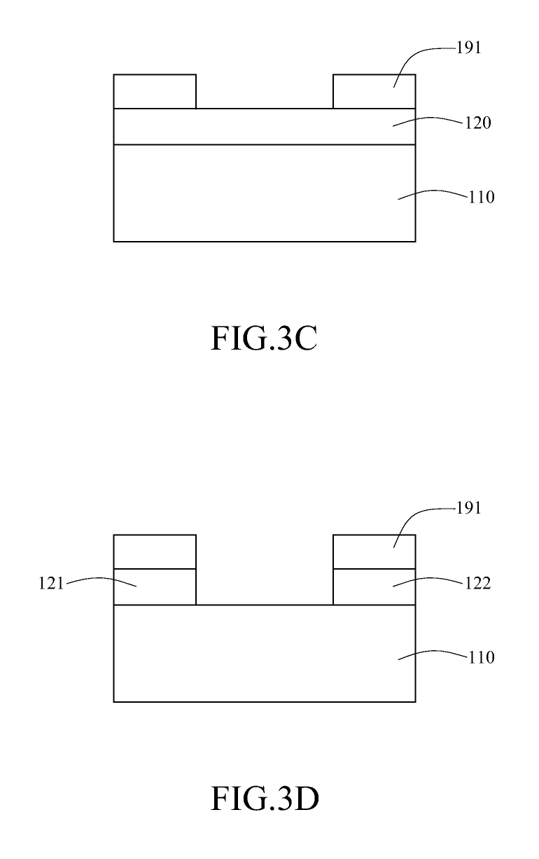

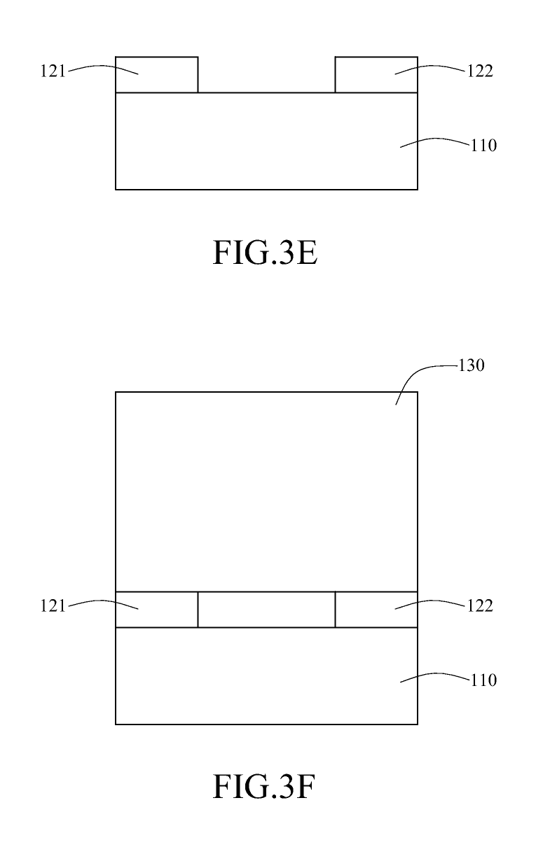

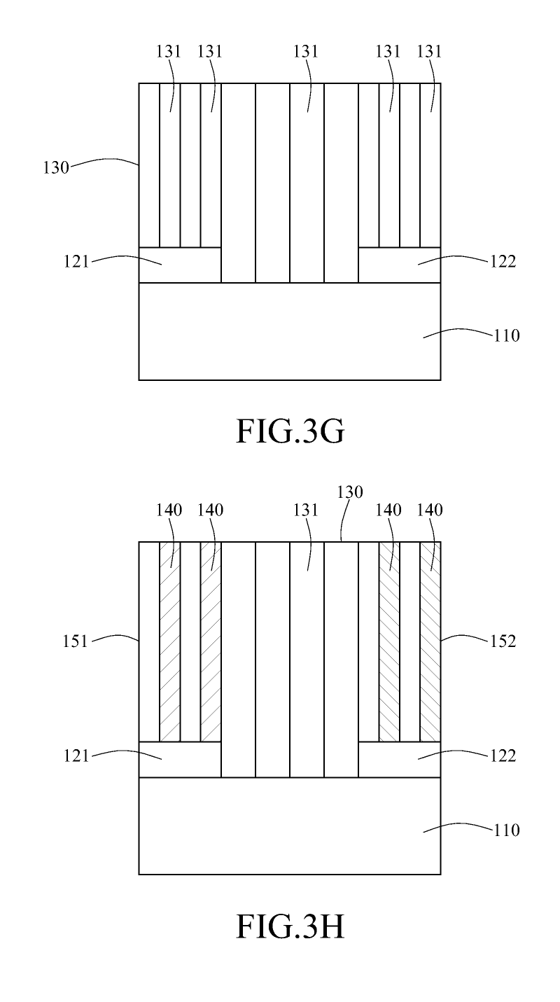

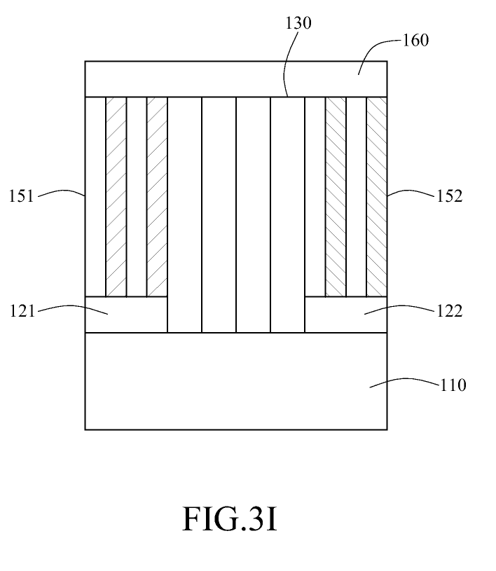

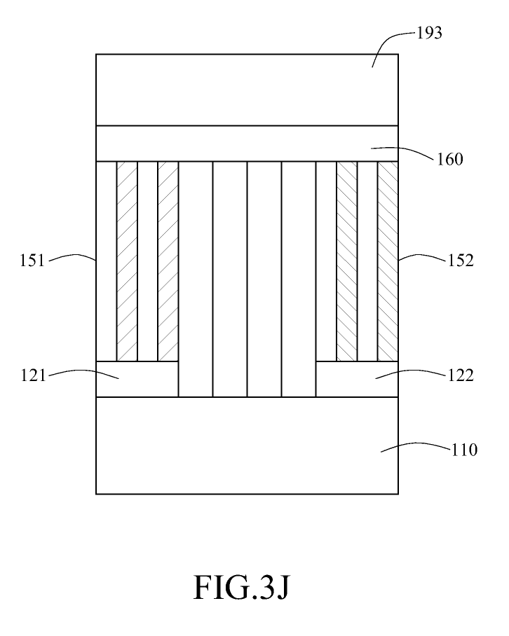

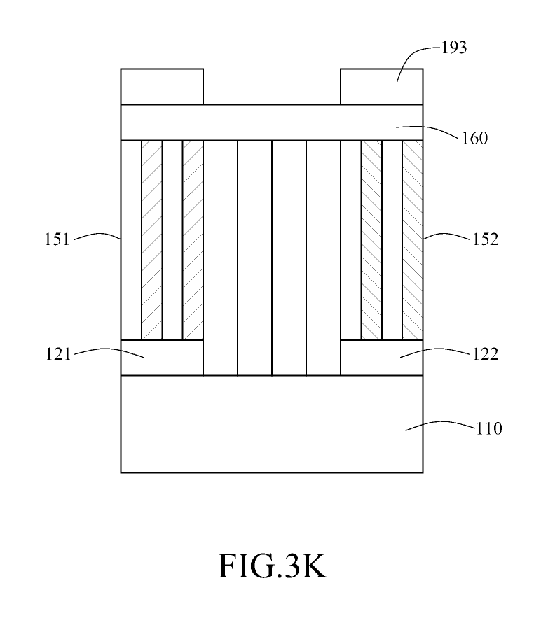

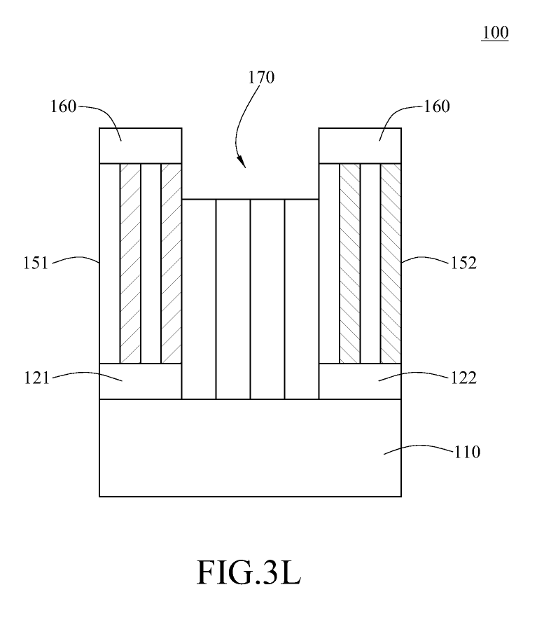

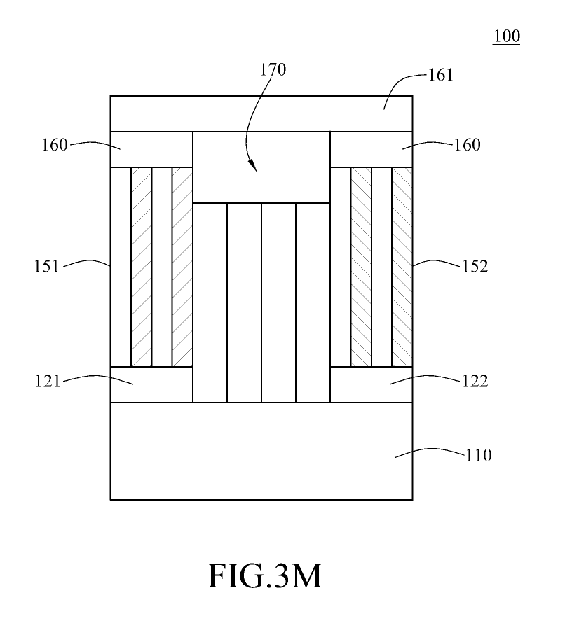

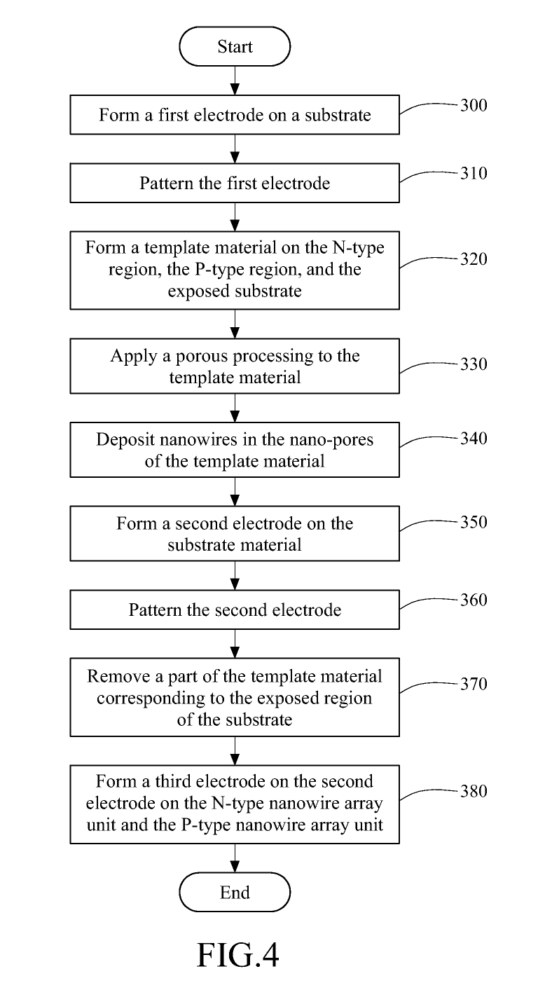

FIGS. 3A to 3L and FIG. 4 are schematic views respectively illustrating steps of a second embodiment of the present invention and a flow chart illustrating steps of the second embodiment of the present invention. Referring to FIGS. 3A to 3E in combination with the flow illustration of steps in FIG. 4, a method for manufacturing a low heat leakage thermoelectric nanowire array according to the second embodiment of the present invention is as follows. First, a first electrode 120 is formed on a substrate 110 (Step 300). The substrate 110 is a silicon wafer, and the first electrode 120 is made of, but not limited to, a nickel metal or a nickel-phosphorus alloy. Then, the first electrode 120 is patterned (Step 310). A first photoresist layer 191 is coated on the first electrode 120, and a part of the first photoresist layer 191 is removed by a lithography process in combination with a physical manner or a chemical manner, so as to correspondingly expose a part of the first electrode 120. Then, the exposed first electrode 120 is removed physically or chemically. Finally, the first phtoresist layer 191 is removed, such that the first electrode 120 forms a structure formed by an N-type region 121 and a P-type region 122 separated from each other, and a part of region (corresponding to a removed part of the first electrode 120) of the substrate 110 is exposed outside.

In the present invention, the part of the first electrode 120 may be removed by wet etching or dry etching methods, and a material of the first photoresist layer 191 is also selected correspondingly according to the employed etching method, and is not limited to the content disclosed in this embodiment.

Referring to FIGS. 3F to 3H in combination with the flow illustration of steps in FIG. 4, after the step of patterning the first electrode 120 (Step 310) is completed, a template material 130 is formed on the N-type region 121, the P-type region 122, and the exposed substrate 110 (Step 320). The template material 130 disclosed in the present invention is made of, but not limited to, an Al₂O₃ material. Then, a porous processing is applied to the template material 130 (Step 330), such that the template material 130 is formed with nano-pores 131 (as shown in FIG. 3G). An aperture of the nano-pores 131 may range from several nanometers to hundreds of nanometers. Then, nanowires 140 are deposited in the nano-pores 131 of the template material 130 (Step 340) at positions corresponding to the N-type region 121 and the P-type region 122, so as to respectively form an N-type nanowire array unit 151 and a P-type nanowire array unit 152 (as shown in FIG. 3H). In the embodiment disclosed in the present invention, the nanowires 140 are deposited in the nano-pores 131 of the template material 130 in an electrochemical manner, for example, an electrochemical co-deposition manner or an electrochemical atomic layer epitaxy manner. Moreover, in the present invention, the nanowires 140 are made of, but not limited to, a Bi-containing material, for example, Bi₂Te₃, or a non-Bi-containing material, for example, PbTe, AgTe, SbTe, SiGe, or a related alloy thereof.

Referring to FIGS. 3I to 3M in combination with the flow illustration of steps in FIG. 4, a second electrode 160 is then formed on the template material 130 (Step 350). Then, the second electrode 160 is patterned (Step 360). A third photoresist layer 193 is coated on the second electrode 160, and a part of the third photoresist layer 193 is removed physically or chemically, so as to correspondingly expose a part of the second electrode 160. A region of the exposed second electrode 160 is corresponding to an exposed region of the substrate 110. Then, the exposed second electrode 160 is removed physically or chemically. Afterwards, the template material 130 under the exposed region is removed partially or completely in a physical or chemical manner (i.e., a region of the template material 130 corresponding to the exposed region of the substrate 110 is removed) (Step 370). Finally, the third photoresist layer 193 is removed, and a third electrode 161 is disposed to connect the second electrode 160 on the N-type nanowire array unit 151 and the second electrode 160 on the P-type nanowire array unit 152 (Step 380), so as to form a thermoelectric nanoarray 100 in the present invention and form an air wall 170. The second electrode 160 and the third electrode 161 are made of, but not limited to, a nickel metal or a nickel-phosphorus alloy.

In the present invention, the part of the second electrode 160 may be removed by wet etching or dry etching methods, and a material of the third photoresist layer 193 is also selected correspondingly according to the employed etching method, and is not limited to the content disclosed in this embodiment.

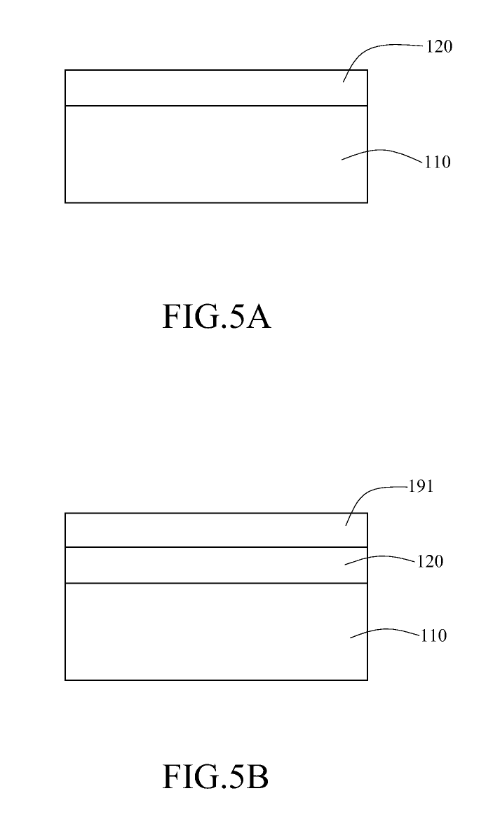

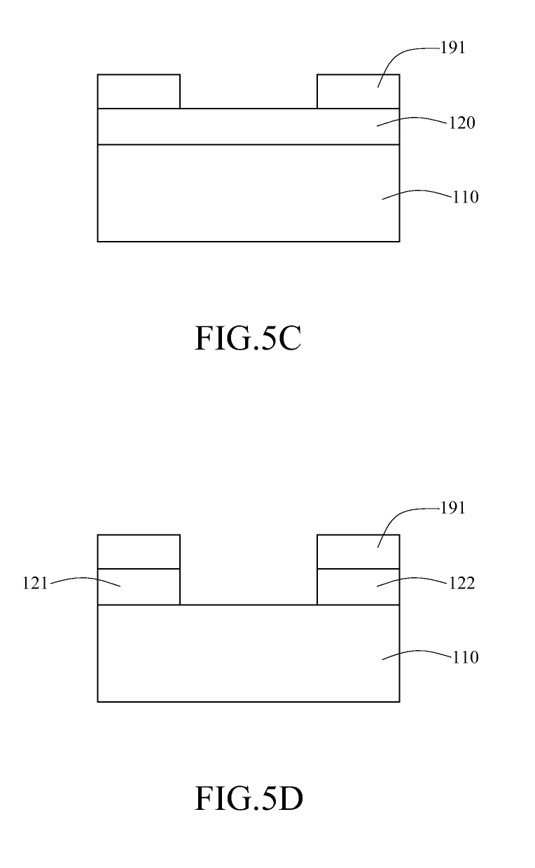

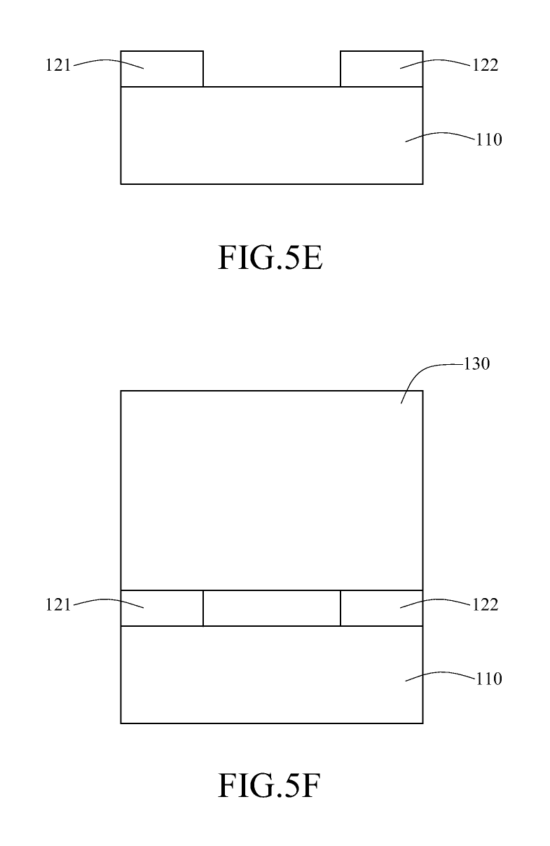

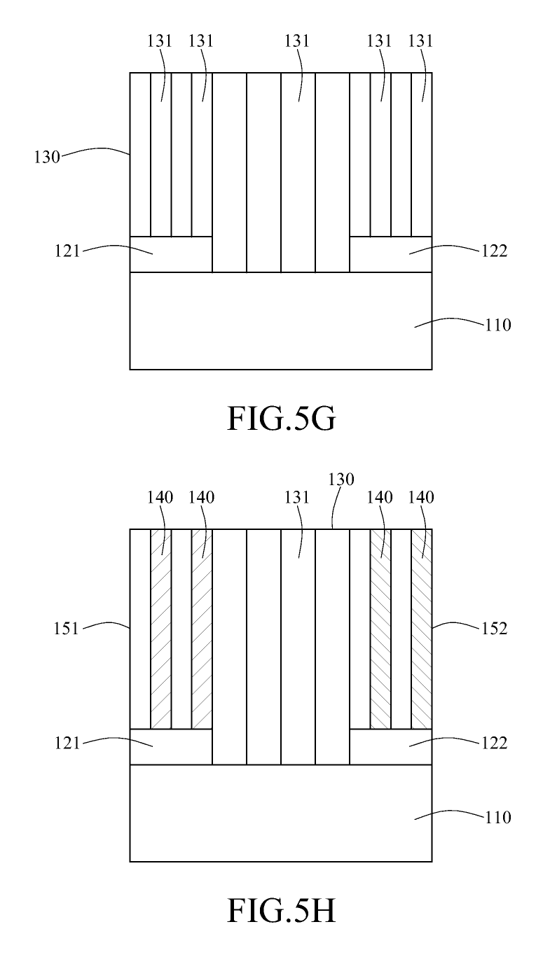

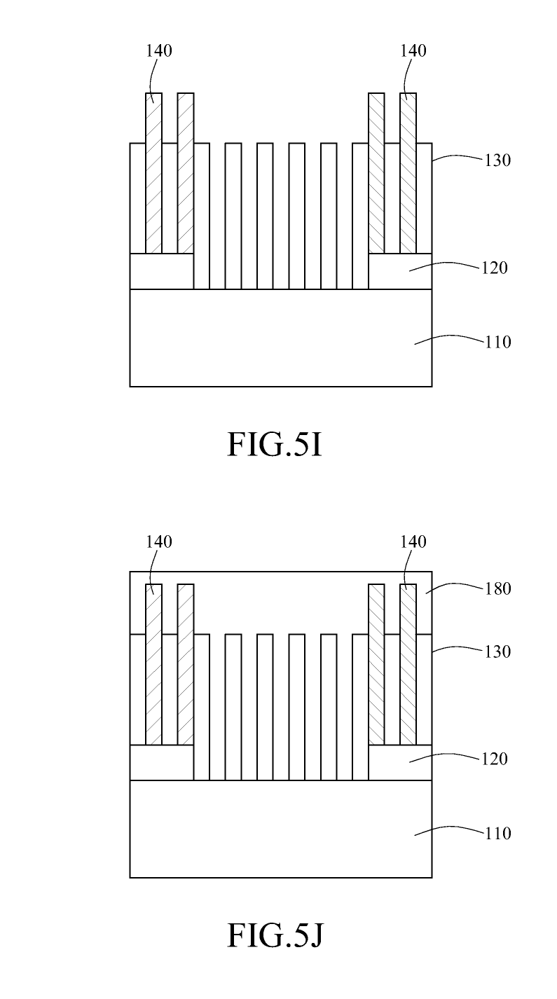

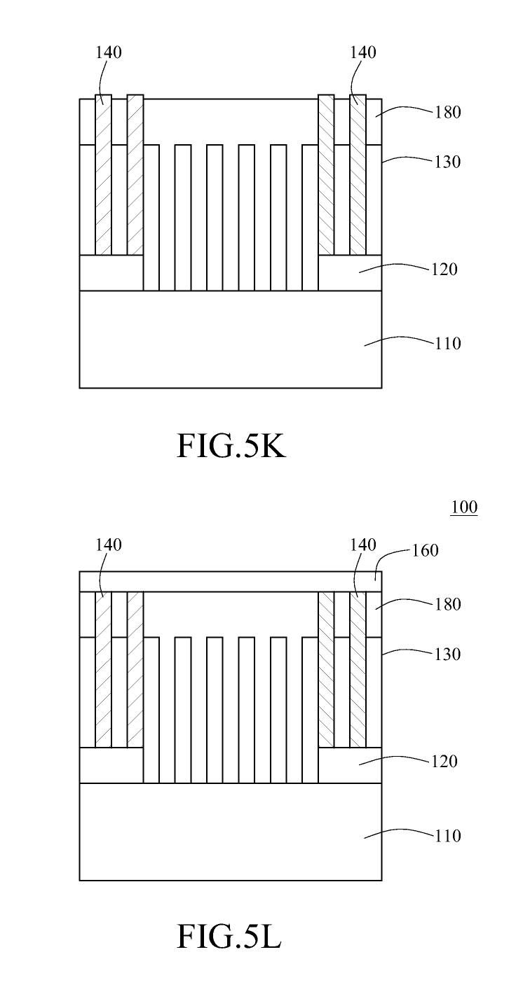

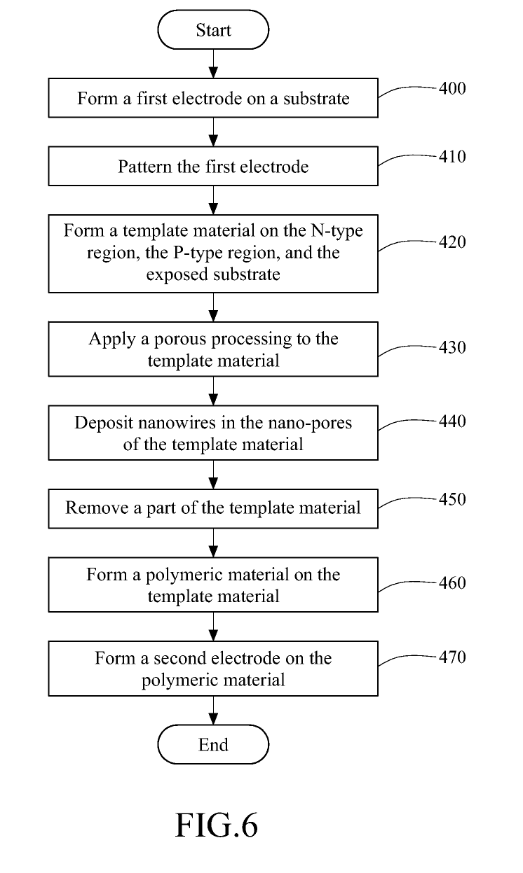

FIGS. 5A to 5L and FIG. 6 are schematic views respectively illustrating steps of a third embodiment of the present invention and a flow chart illustrating steps of the third embodiment of the present invention. Referring to FIGS. 5A to 5E in combination with the flow illustration of steps in FIG. 6, a method for manufacturing a low heat leakage thermoelectric nanowire array according to the third embodiment of the present invention is as follows. First, a first electrode 120 is formed on a substrate 110 (Step 400). The substrate 110 is a silicon wafer, and the first electrode 120 is made of, but not limited to, a nickel metal or a nickel-phosphorus alloy. Then, the first electrode 120 is patterned (Step 410). A first photoresist layer 191 is coated on the first electrode 120, and a part of the first photoresist layer 191 is removed by a lithography process in combination with a physical manner or a chemical manner, so as to correspondingly expose a part of the first electrode 120. Then, the exposed first electrode 120 is removed physically or chemically. Finally, the first phtoresist layer 191 is removed, such that the first electrode 120 forms a structure formed by an N-type region 121 and a P-type region 122 separated from each other, and a part of region (corresponding to a removed part of the first electrode 120) of the substrate 110 is exposed outside.

In the present invention, the part of the first electrode 120 may be removed by wet etching or dry etching methods, and a material of the first photoresist layer 191 is also selected correspondingly according to the employed etching method, and is not limited to the content disclosed in this embodiment.

Referring to FIGS. 5F and 5G in combination with the flow illustration of steps in FIG. 6, a template material 130 is then formed on the N-type region 121, the P-type region 122, and the exposed substrate 110 (Step 420). The template material 130 disclosed in the present invention is made of, but not limited to, an Al₂O₃ material. Then, a porous processing is applied to the template material 130 (Step 430), such that the template material 130 is formed with nano-pores 131. An aperture of the nano-pores 131 may range from several nanometers to hundreds of nanometers.

Referring to FIGS. 5H to 5J in combination with the flow illustration of steps in FIG. 6, nanowires 140 are deposited in the nano-pores 131 of the template material 130 (Step 440) at positions corresponding to the N-type region 121 and the P-type region 122, so as to respectively form an N-type nanowire array unit 151 and a P-type nanowire array unit 152. In the embodiment disclosed in the present invention, the nanowires 140 are deposited in the nano-pores 131 of the template material 130 in an electrochemical manner, for example, an electrochemical co-deposition manner or an electrochemical atomic layer epitaxy manner. Moreover, in the present invention, the nanowires 140 are made of, but not limited to, a Bi-containing material, for example, Bi₂Te₃, or a non-Bi-containing material, for example, PbTe, AgTe, SbTe, SiGe, or a related alloy thereof. Then, a part of the template material 130 is removed (Step 450), such that a part of the nanowires 140 in the nano-pores 131 are exposed outside (as shown in FIG. 5I). Then, a polymeric material 180 is formed on the template material 130 (Step 460) and covers the exposed nanowires 140. The polymeric material 180 disclosed in the present invention has a low thermal conductivity, and is, for example, but not limited to, a resin material.

Referring to FIGS. 5K and 5L in combination with the flow illustration of steps in FIG. 6, if the filled polymeric material 180 is too thick and covers the nanowires 140, a part of the polymeric material 180 must be removed to partially expose the nanowires 140 (as shown in FIG. 5K). Finally, a second electrode 160 is formed on the polymeric material 180 (Step 470), and the second electrode 160 contacts with the exposed nanowires 140, so as to form a thermoelectric nanoarray 100 in the present invention. The second electrode 160 is formed on the polymeric material 180 in an electroless plating manner or a sputtering manner, and the second electrode 160 is made of, but not limited to, a nickel metal or a nickel-phosphorus alloy.

An effective thermal conductivity equation of a composite template structured formed by combining the polymeric material 180 having a low thermal conductivity with the template material 130 disclosed in the third embodiment of the present invention is as follows:

$${λ}_{eff} = ( \frac{1}{\frac{{ϕ}_{template}}{{λ}_{template}} + \frac{{ϕ}_{low thermal conductiv ity material}}{{λ}_{low heat conductivi ty material}}} )$$

where, λₜₑₘₚₗₐₜₑ is the thermal conductivity of the template material, λ_{low thermal conductivity material} is the thermal conductivity of the polymeric material, φₜₑₘₚₗₐₜₑ is the volume fraction of the template material, and φ_{low thermal conductivity material} is the volume fraction of the polymeric material.

When the volume fraction of the polymeric material is high or the thermal conductivity of the polymeric material is low, the polymeric material becomes a dominant factor in the denominator of the above equation, thereby reducing the thermal conductivity of the composite template structure. Taking a Al₂O₃ porous template as an example, the thermal conductivity thereof is 1.7 W/m-K. If a polymeric material of resin SU-8 (the thermal conductivity thereof is 0.2 W/m-K) replaces a part of the Al₂O₃ porous template, and it is assumed that the volume fractions of the Al₂O₃ porous template and the polymeric material 180 are respectively 0.7 and 0.3, the thermal conductivity of the composite template structure is reduced to 0.52 W/m-K. The thermal conductivity of the composite template structure of the present invention is ⅓ of that of the conventional Al₂O₃ porous template, thereby greatly reducing the thermal conduction efficiency of the thermoelectric nanowire array.

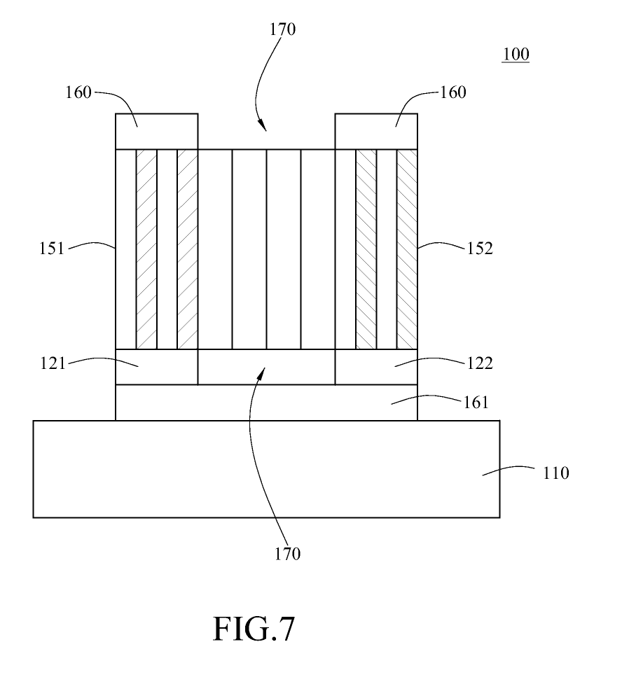

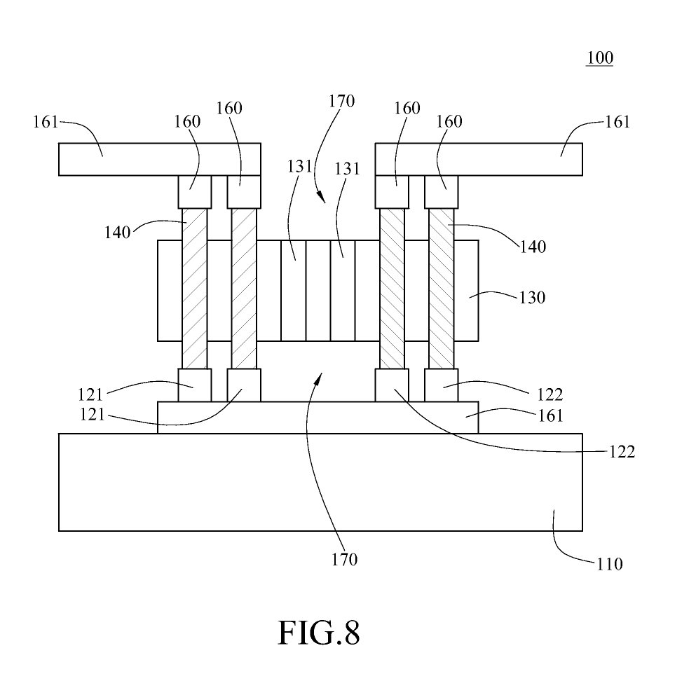

FIGS. 7 and 8 are schematic structural views of a thermoelectric nanowire array in different forms of the present invention. The difference between the thermoelectric nanowire array 100 shown in FIG. 7 and the structure of the second embodiment shown in FIG. 3L lies in that, no template material 130 exists between the N-type region 121 and the P-type region 122 of the first electrode 120, and a third electrode 161 is disposed between the N-type region 121 and the substrate 110 and between the P-type region 122 and the substrate 110. Therefore, after the process steps of forming the template material 130, the template material 130 between the N-type region 121 and the P-type region 122 is removed, such that the air wall 170 exists both between the first electrodes 120 and between the second electrodes 160, thereby effectively blocking the reflux phenomenon of thermal energy. In the thermoelectric nanowire array 100 shown in FIG. 8, the template material 130 at two ends of the nanowires 140 may also be removed, only the template material 130 in the middle of the nanowires 140 is reserved for support, and the air wall 170 is thus formed, so as to greatly reduce the volume of the template material 130 and effectively avoid the heat leakage phenomenon of the thermoelectric nanowire array 100.

It should be noted that, the low heat leakage thermoelectric nanowire array disclosed in the present invention may be independently fabricated into a thermoelectric element (as in the embodiments disclosed in the present invention), and then directly combined with a microelectronic element or an electronic component to be cooled via a thermal interface material, so as to remove thermal energy generated in the operation of the electronic element.

In addition, although the template material is first formed on the silicon substrate and then the nanowire array units are fabricated in all the above embodiments of the present invention, nanowire array units may also be formed on independent template materials first and then assembled to the silicon substrates, which is not limited to the forms or process steps of various embodiments disclosed in the present invention.

In the thermoelectric nanowire array with a low heat leakage and the manufacturing method thereof in the present invention, separated nanowire array units are formed on the substrate to reduce the volume of the template material, and the air wall is formed at a region free of nanowire array units to form a heat leakage barrier layer. Or, the polymeric material having a low thermal conductivity is combined with the template material so as to form a composite template structure for a deposition of nanowires therein, thus reducing the thermal conduction property of the template material. With the design of the air wall or the composite template structure, the heat leakage phenomenon of the thermoelectric nanowire array is reduced, and parasitic heat transferred back from the template material to a low-temperature area due to heat leakage effect is reduced, thereby greatly improving a thermal dissipation efficiency of the thermoelectric nanowire array.

What is claimed is:

1. A method for manufacturing a thermoelectric nanowire array with a low heat leakage, comprising:
forming a first electrode on a substrate;
patterning the first electrode, so as to form an N-type region and a P-type region separated from each other and expose a part of the substrate;
forming a template material on the N-type region, the P-type region, and the exposed substrate;
patterning the template material, so as to remove the template material on the exposed substrate;
applying a porous processing to the template material, such that the template material is formed with at least one nano-pore;
depositing at least one nanowire in the nano-pore of the template material, so as to respectively form an N-type nanowire array unit and a P-type nanowire array unit; and
forming a second electrode connecting the N-type nanowire array unit and the P-type nanowire array unit and forming an air wall between the N-type nanowire array unit and the P-type nanowire array unit.

2. The method for manufacturing a thermoelectric nanowire array with a low heat leakage according to claim 1, wherein the substrate is made of a silicon wafer.

3. The method for manufacturing a thermoelectric nanowire array with a low heat leakage according to claim 1, wherein the template material is made of an Al₂O₃ material.

4. The method for manufacturing a thermoelectric nanowire array with a low heat leakage according to claim 1, wherein the first electrode and the second electrode are made of a nickel metal or a nickel-phosphorus alloy.

5. The method for manufacturing a thermoelectric nanowire array with a low heat leakage according to claim 1, wherein the first electrode forms the N-type region and the P-type region by a lithography process.

6. The method for manufacturing a thermoelectric nanowire array with a low heat leakage according to claim 1, wherein the template material on the exposed substrate is removed physically or chemically.

7. The method for manufacturing a thermoelectric nanowire array with a low heat leakage according to claim 1, wherein the nanowire is deposited in the nano-pore of the template material in an electrochemical manner.

8. The method for manufacturing a thermoelectric nanowire array with a low heat leakage according to claim 1, wherein the nanowire is made of a Bi-containing material or a non-Bi-containing material.

9. The method for manufacturing a thermoelectric nanowire array with a low heat leakage according to claim 8, wherein the nanowire is made of a Bi₂Te₃ material or a related alloy thereof.

10. The method for manufacturing a thermoelectric nanowire array with a low heat leakage according to claim 8, wherein the nanowire is made of a PbTe material, an AgTe material, an SbTe material, an SiGe material, or a related alloy thereof.

11. A method for manufacturing a thermoelectric nanowire array with a low heat leakage, comprising:
forming a first electrode on a substrate;
patterning the first electrode, so as to form an N-type region and a P-type region separated from each other and expose a part of the substrate;
forming a template material on the N-type region, the P-type region, and the exposed substrate;
applying a porous processing to the template material, such that the template material is formed with a plurality of nano-pores;
depositing at least one nanowire in the nano-pores of the template material at positions corresponding to the N-type region and the P-type region, so as to respectively form an N-type nanowire array unit and a P-type nanowire array unit;
forming a second electrode on the template material;
patterning the second electrode, so as to remove the part of the second electrode corresponding to the exposed substrate area, and to keep the part of the second electrode above the N-type nanowire array unit and the P-type nanowire array unit;
removing a part of the template material corresponding to the exposed substrate; and
forming a third electrode on the second electrode connecting the N-type nanowire array unit and the P-type nanowire array unit, so as to form an air wall.

12. The method for manufacturing a thermoelectric nanowire array with a low heat leakage according to claim 11, wherein the substrate is made of a silicon wafer.

13. The method for manufacturing a thermoelectric nanowire array with a low heat leakage according to claim 11, wherein the template material is made of an Al₂O₃ material.

14. The method for manufacturing a thermoelectric nanowire array with a low heat leakage according to claim 11, wherein the first electrode, the second electrode, and the third electrode are made of a nickel metal or a nickel-phosphorus alloy.

15. The method for manufacturing a thermoelectric nanowire array with a low heat leakage according to claim 11, wherein the first electrode forms the N-type region and the P-type region by a lithography process.

16. The method for manufacturing a thermoelectric nanowire array with a low heat leakage according to claim 11, wherein the second electrode except on the N-type nanowire array unit and on the P-type nanowire array unit is removed physically or chemically.

17. The method for manufacturing a thermoelectric nanowire array with a low heat leakage according to claim 11, wherein the nanowire is deposited into the nano-pores of the template material in an electrochemical manner.

18. The method for manufacturing a thermoelectric nanowire array with a low heat leakage according to claim 11, wherein the nanowire is made of a Bi-containing material or a non-Bi-containing material.

19. The method for manufacturing a thermoelectric nanowire array with a low heat leakage according to claim 18, wherein the nanowire is made of a Bi₂Te₃ material or a related alloy thereof.

20. The method for manufacturing a thermoelectric nanowire array with a low heat leakage according to claim 18, wherein the nanowire is made of a PbTe material, an AgTe material, an SbTe material, an SiGe material, or a related alloy thereof.

21. A method for manufacturing a thermoelectric nanowire array with a low heat leakage, comprising:
forming a first electrode on a substrate;
patterning the first electrode, so as to form a N-type region and a P-type region separated from each other and expose a part of the substrate;
forming a template material on the N-type region, the P-type region, and the exposed substrate;
applying a porous processing to the template material, such that the template material is formed with a plurality of nano-pores;
depositing at least one nanowire into the nano-pores of the template material at positions corresponding to the N-type region and the P-type region, so as to respectively form an N-type nanowire array unit and a P-type nanowire array unit;
removing a part of the template material, so as to expose a part of the nanowire;
forming a polymeric material on the template material, so as to cover the nanowire and expose a part of the nanowire; and
forming a second electrode on the polymeric material, wherein the second electrode contacts with the exposed nanowire and connect the N-type nanowire array unit and the P-type nanowire array unit.

22. The method for manufacturing a thermoelectric nanowire array with a low heat leakage according to claim 21, wherein the substrate is made of a silicon wafer.

23. The method for manufacturing a thermoelectric nanowire array with a low heat leakage according to claim 21, wherein the template material is made of an Al₂O₃ material.

24. The method for manufacturing a thermoelectric nanowire array with a low heat leakage according to claim 21, wherein the polymeric material is made of a resin material.

25. The method for manufacturing a thermoelectric nanowire array with a low heat leakage according to claim 21, wherein the first electrode and the second electrode are made of a nickel metal or a nickel-phosphorus alloy.

26. The method for manufacturing a thermoelectric nanowire array with a low heat leakage according to claim 21, wherein the nanowire is deposited in the nano-pores of the template material in an electrochemical manner.

27. The method for manufacturing a thermoelectric nanowire array with a low heat leakage according to claim 21, wherein the nanowire is made of a Bi-containing material or a non-Bi-containing material.

28. The method for manufacturing a thermoelectric nanowire array with a low heat leakage according to claim 27, wherein the nanowire is made of a Bi₂Te₃ material or a related alloy thereof.

29. The method for manufacturing a thermoelectric nanowire array with a low heat leakage according to claim 27, wherein the nanowire is made of a PbTe material, an AgTe material, an SbTe material, an SiGe material, or a related alloy thereof.

30. A thermoelectric nanowire array with a low heat leakage, comprising:
a substrate;
a first electrode, disposed on the substrate, and having an N-type region and a P-type region separated from each other;
a template material, disposed on the N-type region and the P-type region of the first electrode, and having at least one nano-pore;
at least one nanowire, disposed in the nano-pore of the template material so as to form an N-type nanowire array unit and a P-type nanowire array unit with the template material on the N-type region and the P-type region; and
a second electrode, disposed on the N-type nanowire array unit and the P-type nanowire array unit, such that the N-type nanowire array unit and the P-type nanowire array unit form an air wall.

31. The thermoelectric nanowire array with a low heat leakage according to claim 30, wherein the substrate is a silicon wafer.

32. The thermoelectric nanowire array with a low heat leakage according to claim 30, wherein the template material is made of an Al₂O₃ material.

33. The thermoelectric nanowire array with a low heat leakage according to claim 30, wherein the first electrode and the second electrode are made of a nickel metal or a nickel-phosphorus alloy.

34. The thermoelectric nanowire array with a low heat leakage according to claim 30, wherein the nanowire is made of a Bi-containing material or a non-Bi-containing material.

35. The thermoelectric nanowire array with a low heat leakage according to claim 34, wherein the nanowire is made of a Bi₂Te₃ material or a related alloy thereof.

36. The thermoelectric nanowire array with a low heat leakage according to claim 34, wherein the nanowire is made of a PbTe material, an AgTe material, an SbTe material, an SiGe material, or a related alloy thereof.

37. A thermoelectric nanowire array with a low heat leakage, comprising:
a substate;
a first electrode, disposed on the substrate, having an N-type region and a P-type region separated from each other, and having the exposed substrate between the N-type region and the P-type region;
a template material, disposed on the N-type region, the P-type region, and the exposed substrate, and having a plurality of nano-pores;
at least one nanowire, disposed in the nano-pores of the template material, corresponding to positions of the N-type region and the P-type region, and forming an N-type nanowire array unit and a P-type nanowire array unit with the template material on the N-type region and the P-type region;
a second electrode, disposed on the N-type nanowire array unit and the P-type nanowire array unit; and
a third electrode, disposed on the second electrode connecting the N-type nanowire array unit and the P-type nanowire array unit, and forming an air wall at a relative position corresponding to the exposed substrate.

38. The thermoelectric nanowire array with a low heat leakage according to claim 37, wherein the substrate is a silicon wafer.

39. The thermoelectric nanowire array with a low heat leakage according to claim 37, wherein the template material is made of an Al₂O₃ material.

40. The thermoelectric nanowire array with a low heat leakage according to claim 37, wherein the first electrode, the second electrode, and the third electrode are made of a nickel metal or a nickel-phosphorus alloy.

41. The thermoelectric nanowire array with a low heat leakage according to claim 37, wherein the nanowire is made of a Bi-containing material or a non-Bi-containing material.

42. The thermoelectric nanowire array with a low heat leakage according to claim 41, wherein the nanowire is made of a Bi₂Te₃ material or a related alloy thereof.

43. The thermoelectric nanowire array with a low heat leakage according to claim 41, wherein the nanowire is made of a PbTe material, an AgTe material, an SbTe material, an SiGe material, or a related alloy thereof.

44. A thermoelectric nanowire array with a low heat leakage, comprising:
a substate;
a first electrode, disposed on the substrate,
a template material, disposed on the first electrode, and having a plurality of nano-pores;
at least one nanowire, disposed in the nano-pores of the template material and partially exposed outside the nano-pore;
a polymeric material, disposed on the template material and partially covering the exposed nanowire; and
a second electrode, disposed on the polymeric material, and contacting with the exposed nanowire.

45. The thermoelectric nanowire array with a low heat leakage according to claim 44, wherein the substrate is a silicon wafer.

46. The thermoelectric nanowire array with a low heat leakage according to claim 44, wherein the template material is made of an Al₂O₃ material.

47. The thermoelectric nanowire array with a low heat leakage according to claim 44, wherein the polymeric material is made of a resin material.

48. The thermoelectric nanowire array with a low heat leakage according to claim 44, wherein the first electrode and the second electrode are made of a nickel metal or a nickel-phosphorus alloy.

49. The thermoelectric nanowire array with a low heat leakage according to claim 44, wherein the nanowire is made of a Bi-containing material or a non-Bi-containing material.

50. The thermoelectric nanowire array with a low heat leakage according to claim 49, wherein the nanowire is made of a Bi₂Te₃ material or a related alloy thereof.

51. The thermoelectric nanowire array with a low heat leakage according to claim 49, wherein the nanowire is made of a PbTe material, an AgTe material, an SbTe material, an SiGe material, or a related alloy thereof.
